(19) United States
(12) Patent Application Publication
(10) Pub. No.: US 2014/0372284 A1
(43) Pub. Date: Dec. 18, 2014

(54) System, Methods, and Computer-Readable Media for Determining an Entity Score Based on User Behaviors Associated with an Entity

(71) Applicant: Google Inc., Mountain View, CA (US)

(72) Inventors: Zoltan Stekkelpak, Mountain View, CA (US); Gyula Simonyi, Dublin (IE)

(21) Appl. No.: 13/712,640

(22) Filed: Dec. 12, 2012

(51) Int. Cl. G06Q 40/00

(52) U.S. Cl. CPC G06Q 40/00
USPC 705/39

(57) ABSTRACT

Provided are systems, methods, and computer-readable media for determining an entity score based on user behaviors associated with an entity. Various user behaviors are obtained from payment services, location services and other services. The user behaviors are based on payment transactions with an entity, user presences at an entity, and user selections of entity relative to alternative entities. Based on the user behaviors, positive or negative coring signals are determined and used to modify an entity score associated with the entity.

### BACKGROUND OF THE INVENTION

1. Field of the Invention

This invention relates generally to ratings and reviews of businesses and other entities and, more particularly, to scoring businesses based on user behaviors.

2. Description of the Related Art

The Internet is useful for a variety of purposes. For example, users may use the Internet to search for entities of interest and to retrieve information about businesses or other entities. Additionally, users may search for ratings, reviews, and other explicit feedback provided by other users. A user may decide to purchase items from or patronize an entity based on the ratings, reviews, and other explicit feedback. Additionally, search engines or other data aggregation mechanisms may assign scores to entities based on the ratings and reviews provided by other users. However, such ratings and reviews require manual entry by other users and may be subject to bias from users. The ratings and reviews may also be susceptible to spam or other activities that affect the accuracy of the ratings and reviews.

### SUMMARY OF THE INVENTION

Various embodiments of methods, computer-readable media, and systems for determining an entity score based on user behaviors associated with an entity are provided herein. In some embodiments, provided is a computer-implemented method for determining an entity score based on user behaviors associated with an entity. The method includes identifying, one or more processors, a plurality of user payment transactions with the entity and comparing an average tip amount determined from the plurality of user payment transactions with a baseline tip amount determined from historical user payment transactions to determine a scoring signal. The method further includes modifying, by one or more processors, a score associated with the entity based on the scoring signal and storing, by one or more processors, the score and an entity identifier associated with the entity.

Additionally, in some embodiments a non-transitory tangible computer-readable storage medium having executable computer code stored thereon for determining a score associated with an entity based on user behaviors is provided. The code includes a set of instructions that causes one or more processors to perform the following: identifying, one or more processors, a plurality of user payment transactions with the entity and comparing an average tip amount determined from the plurality of user payment transactions with a baseline tip amount determined from historical user payment transactions to determine a scoring signal. The code further includes a set of instructions that causes one or more processors to perform the following: modifying, by one or more processors, a score associated with the entity based on the scoring signal and storing, by one or more processors, the score and an entity identifier associated with the entity.

Further, in some embodiments, a system for determining a score associated with an entity based on user behaviors is provided. The system includes one or more processors; and non-transitory memory accessible by the one or more processors, the memory having computer code stored thereon. The code includes a set of instructions that causes one or more processors to perform the following: identifying, one or more processors, a plurality of user payment transactions with the entity and comparing an average tip amount determined from the plurality of user payment transactions with a baseline tip amount determined from historical user payment transactions to determine a scoring signal. The code further includes a set of instructions that causes one or more processors to perform the following: modifying, by one or more processors, a score associated with the entity based on the scoring signal and storing, by one or more processors, the score and an entity identifier associated with the entity.

### BRIEF DESCRIPTION OF THE DRAWINGS

FIG. 1 is a block diagram that illustrates the determination user behaviors used to modify entity score of an entity in accordance with an embodiment of the present invention;

FIG. 2 is a schematic diagram of a system for determining user behaviors in accordance with an embodiment of the present invention;

FIG. 3 depicts a process 300 for determining user behavior scoring signals from a payment service in accordance with an embodiment of the present invention;

FIG. 4 depicts a process 400 for determining user behavior scoring signals from a location-based service in accordance with an embodiment of the present invention;

FIG. 5 depicts a process 500 for determining user behavior scoring signals from user choices in accordance with an embodiment of the present invention; and

FIG. 6 is a diagram of a computer in accordance with embodiments of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for determining an entity score based on user behaviors associated with an entity. User behaviors are determined from user interactions with various services, such as a payment-based service, location-based service, and other services. The user behaviors include payment behaviors (e.g., tipping behaviors), location behaviors (e.g., repeat presences at an entity), and choice behaviors (e.g., selecting an entity over other entities in a geographic area).

A user interacts with payment-based services, location-based services, and other services using a client computer. The user behaviors are determined from data obtained from the payment-based services, location-based services, and other services. For example, an average tip amount and tipping frequency is determined from payment transactions to an entity obtained from the payment-based services. Based on an evaluation of the average tip amount, tipping frequency, or both, a positive scoring signal or negative scoring signal is determined. The scoring signal is used to modify, e.g., increase or decrease, an entity score associated with an entity. In another example, users' presences at an entity are obtained from a location-based service, and the ratio of returning users to one-time users is determined. Based on the ratio, a positive scoring signal or negative scoring signal is determined and used to modify, e.g., increase or decrease, an entity score associated with an entity. In yet another example, user presences at an entity over a time period are determined and alternative entities in a geographic area are determined. The user presences at the selected entity are evaluated based on a comparison to the alternative entities. Based on the user's selection of the selected entity over alternative entities, a positive scoring signal is determined and used to modify, e.g., increase, an entity score associated with an entity.

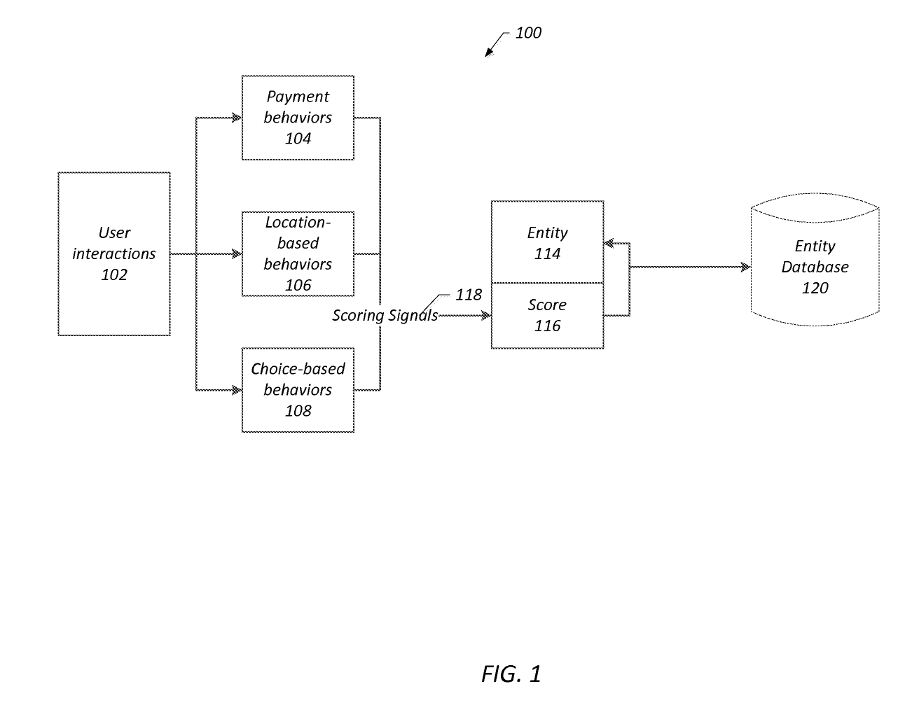

FIG. 1 depicts a system 100 illustrating the obtaining of user behaviors that are used for scoring entities in accordance with an embodiment of the present invention. As shown in FIG. 1, various user interactions 102 related to an entity 114 may occur. As used herein, the term “entity” refers to a private or public entity that is capable of providing for the some or all of user interactions described herein. An entity may or may not have a physical location. In some embodiments, for example, an entity includes a business (e.g., a restaurant, bar, retail store), a public facility (e.g., a library, a museum, a park), and other similar entities.

The user interactions 102 may indicate various user behaviors that can be used as signals in scoring an entity affected by the user interactions 102. The user interactions 102 may include, for example, payment transactions to an entity, the presence of a user at an entity (as determined from the user's location), the selection of an entity from other entities, and other user action. As shown in FIG. 1, payment behaviors 104 are collected from user interactions. The payment behaviors 104 may include whether a user added a tip to a payment to an entity, the amount of the tip, the frequency of tipping to an entity, and other payment behaviors. Additionally, location based behaviors 106 may be collected from user interactions 102. The location-based behaviors 106 may include whether users repeatedly returned to an entity, whether users only visited an entity once and never returned, and other location-based behaviors. Choice-based behaviors 108 may also be collected from the user interactions 102. The choice based behaviors may include whether users selected an entity from other entities within specific geographic distance in a similar category, and other choices that indicate a preference for an entity.

As shown in FIG. 1, the payment behaviors 104, the location-based behaviors 106, and the choice-based behaviors 108 are used to affect a score 116 associated with the entity 114. In some embodiments, for example, the behaviors 104, 106, and 108 are used as qualitative scoring signals 118 to increase or decrease a score 116 associated with the entity 114. The score 116 associated with an entity 114 may be previously determined based on explicit feedback for the entity provided by users, such as explicit ratings and reviews, or may be a baseline score, such as zero. As will be appreciated, such explicit ratings and reviews are obtained from websites and applications that receive and aggregate user ratings and reviews for entities. The determined score 116 and the associated entity 114 are stored in an entity database 120. The entity database 120 may include entity identifiers and the associated entity scores for each entity. The entity database 120 may then be used to provide the score for an entity to other systems, such as search engines that provide information about an entity. For example, the entity 114 may be ranked with other entities based on the entity score 116, and the ranked entities may be provided to a client computer in response to a search query.

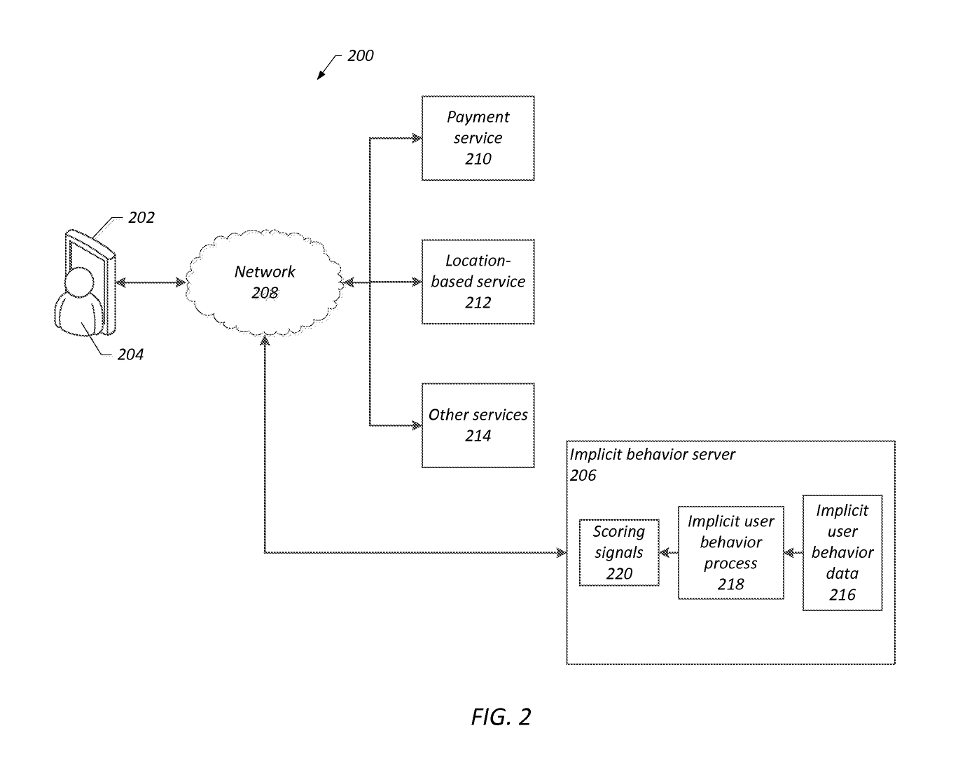

FIG. 2 depicts a system 200 illustrating the collection of user behaviors and the determination of a scoring signal based on such user behaviors in accordance with an embodiment of the present invention. The system 200 includes a client computer 202 associated with a user 204 and a user behavior server 206. The client computer 202 and user behavior server 206 are in communication with a network 208. The client computer 202 may include laptop computers, tablet computers, smartphones, personal digital assistants, etc., and may include a receiver for a satellite-based positioning system, such as a Global Positioning System (GPS) receiver. In some embodiments, the client computer 202 may include a desktop computer. A user may use the client computer 202 to retrieve information, view interactive maps, and perform computer-implemented searches, such as by searching the World Wide Web using a web-based search engine or by searching an interactive map of a geographic area.

The user behavior server 206 may be a single server (in a discrete hardware component or as a virtual server) or multiple servers. The user behavior server 206 may include web servers, application servers, or other types of servers. Additionally, the user behavior server 206 may be, for example, computers arranged in any physical and virtual configuration, such as computers in one or more data processing centers, a distributed computing environment, or other configuration. Such configurations may use the network 208 for communication or may communicate over other networks.

The client computer 202 and user behavior server 206 are in communication with the network 208, such as through a wired or wireless network interface. In some embodiments, the network 208 may include multiple networks, and may include any suitable network and networking technology, such as the Internet, an intranet, a local area network (LAN), a wide area network (WAN), or any other suitable network. Additionally, the network 208 may include a wired network, a wireless network, or both. Moreover, it should be appreciated that the client computer 202 and user behavior server 206 may communicate over different networks separately and simultaneously. For example, the client computer 202 may communicate over both a wireless Ethernet network and a cellular network.

As shown in FIG. 2, various services accessed by the client computer may communicate over the network 208 in the manner described above and may provide for the collection of user behaviors. In some embodiments, a payment service 210 is accessed by the client computer 202 and used to make payment transactions to entities. The payment service 210 may include online payment services, mobile payment services, and other payment services. In some embodiments, the mobile payment services may include near field communication (NFC) based services to enable a user to use the client computer 202 to make a payment at an entity having an NFC enabled terminal. The payment service 210 provides for the collection of payment behaviors, such as whether the user 204 tipped, the amount of tips, the frequency of tips, and so on.

In some embodiments, a location-based service 212 is accessed by the client computer 202. The location-based service 212 enables the user 204 to indicate his or her present location, either manually (e.g., via manual check-ins and check-outs at entity), automatically (e.g., via position data), or both. In some embodiments, the position data includes GPS data, A-GPS data, Wi-Fi based location data, or other position data. The user 204 may decide whether to make his or her location available via the location-based service 212. The location-based service 212 provides for the collection of location-based behaviors, such as whether users frequently return to an entity or do not return to an entity.

Additionally, other services 214 are accessed by the client computer 202 and provide for the collection of other user behaviors. For example, the other services 214 may include geographic-map based services that enable the user 204 to search for entities in a geographic area. Based on such searches and the selection of an entity from other entities in the geographic area, choice-based behaviors are provided.

The user behavior 206 obtains the user behavior data 216 from the various services 210, 212, and 214. The user behavior data 216 is processed by a user behavior process 218 to determine scoring signals 220. As described above, for example, the scoring signals 200 modify an entity score associated with an entity. For example, the user behaviors may indicate that the user 204 generated negative behaviors towards an entity, such as by leaving a low tip amount or no tip. The scoring signals 200 associated with such a behavior may be negative and may result in a decrease of the entity score. In contrast, the user behaviors may indicate that the user 204 generated positive behaviors towards an entity, such as by leaving a large tip amount or frequent tips. The scoring signals 220 associated with such a behavior may be positive and may result in an increase of the entity score associated with the entity. In some embodiments, the scoring signals discussed herein may be segmented by aggregated demographics for groups of users. In such embodiments, scoring signals from users having similar demographics may be assigned a higher weight than other scoring signals when using the scoring signal in entity scoring for the similar users.

In embodiments in which the systems discussed herein collect information about users, or may make use of such information, the users may be provided with an opportunity to control whether programs or features collect user information (e.g., user payment transactions, user locations, user preferences, or other user information). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is obtained about the user and used by the processes described herein.

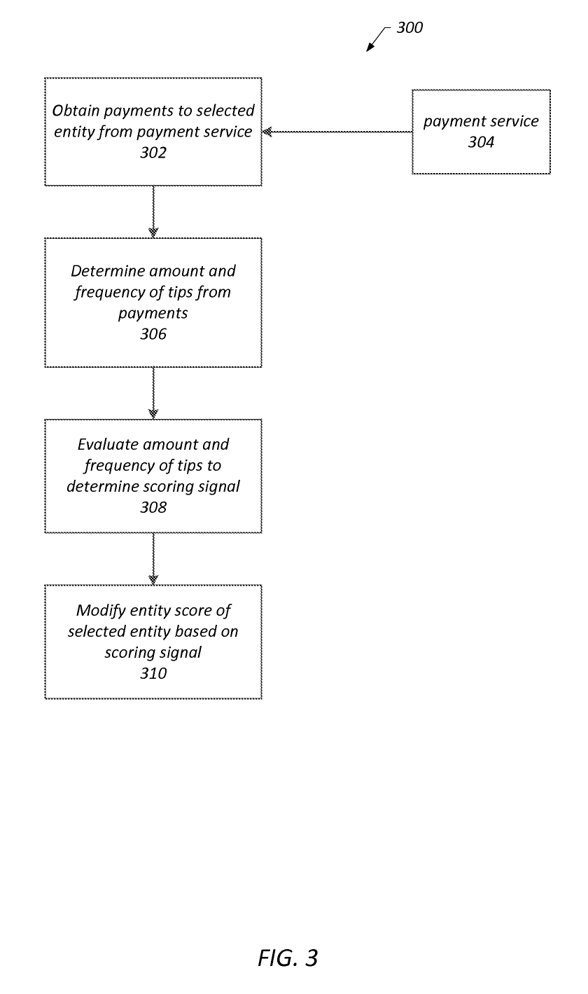

FIGS. 3, 4, and 5 depict processes for determining scoring signals from different user behaviors in accordance with an embodiment of the present invention. FIG. 3 depicts a process 300 for determining scoring signals from a payment service in accordance with an embodiment of the present invention. Initially, aggregated payment transactions to an entity are obtained (block 302) from a payment service 304. As described above, in some embodiments the payment service 304 may include a mobile payment service accessed by the client computer 202, such as NFC-based mobile payment service. The payment transactions may include, for example, payment amounts for goods or services obtained from an entity, and tip amounts associated with the payment.

Next, the amount of the tips, the frequency of tips, or both are determined from the payment transactions (block 306). For example, the frequency of tips may be determined relative to payment transactions for a single user (e.g., whether a single user frequency tipped on payment transactions to an entity) or payment transactions for multiple users (e.g., whether multiple users tipped on payment transactions to an entity). The amount of tips, the frequency of tips, or both are evaluated to determine a scoring signal based on the evaluation (block 308). The evaluation may include evaluating an average tip amount relative to a baseline tip amount. As used herein, the term “average tip amount” may include computed aggregated tip amount derivatives and may be determined via different factors, multipliers, weights, adjustments, smoothing variables, other statistical formula or combination thereof. The baseline tip amount may be based on tip amounts to other entities in a geographic area, other entities in a similar category, other baseline tip amounts or a combination thereof. For example, in some embodiments the evaluation may include comparing a user's tip amount to the same user's tip amounts paid to entitles having the same entity category and within the same geographic area. In some embodiments, the evaluation may include comparing the average tip amount for an entity for multiple users to the average tip amount paid to other entities having the same entity category and within the same geographic area. It should be appreciated that a tip percentage may be used instead of a tip amount and obtained and evaluated in the manner described above. The evaluation may also include evaluating the frequency of tips relative to a baseline tip frequency. Here again, the baseline tip frequency may be based on tips to other entities in a geographic area, tip to other entities in a similar category, other tips, or a combination thereof.

A scoring signal is determined based on the evaluation of the amount of tips, the frequency of tips, or both. For example, if the aggregated payment transactions indicate that users tipped a tip amount that is a threshold percentage higher than a baseline tip amount associated with entities in a similar category, a positive scoring signal may be determined. The value of the positive scoring signal may be proportional to the difference between the average tip amount from the aggregated payment transactions and the baseline tip amount. Similarly, if the aggregated payment transactions indicate that users tipped a tip amount that is a threshold percentage lower than a baseline tip amount associated with entities in a similar category, a negative scoring signal may be determined. The value of the negative scoring signal may be proportional to the difference between the average tip amount from the aggregated payment transactions and the baseline tip amount.

After determining a scoring signal based on the aggregated payment transactions, an entity score associated with the entity is modified (block 310). For example, the entity score may be increased if a positive scoring signal is determined from the aggregated payment transactions and may be decreased if a negative scoring signal is determined from the aggregated payment transactions. The increase or decrease of the entity score may be proportional to the value of the scoring signal providing the basis for the modification of the entity score.

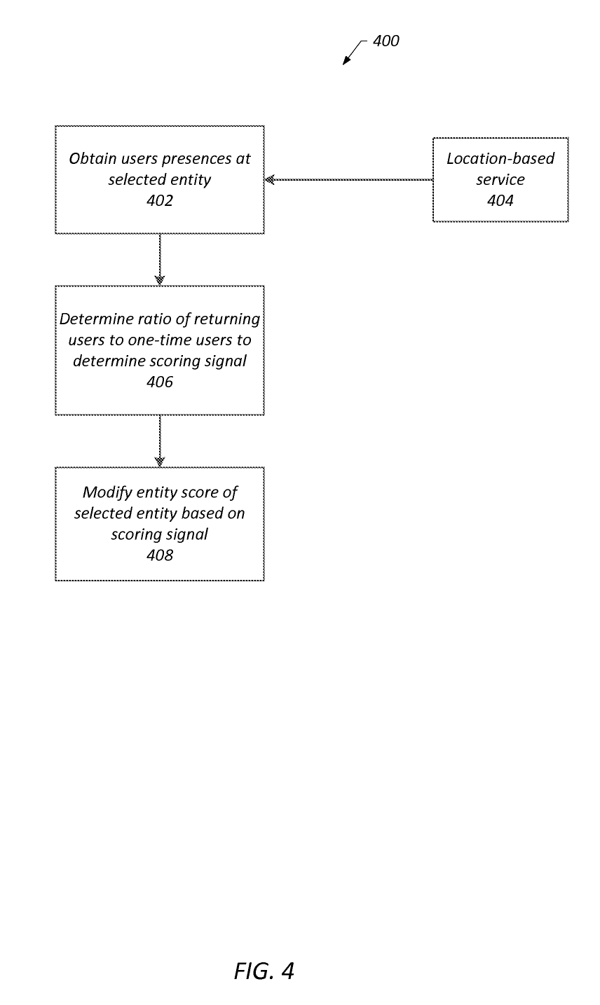

FIG. 4 depicts a process 400 for determining scoring signals from a location-based service in accordance with an embodiment of the present invention. Initially, users' presences at an entity are obtained (block 402) from a location based service 404. As described above, a user presence may be determined by the location based service from a manual indication, such as a check-in or check-out by a user, or an automatic indication based on position data, such as GPS data. The users' presences may include presences obtained over a time period, such as 1 day, multiple days, 1 week, multiple weeks, 1 month, multiple month, 1 year, multiple years, or any other duration.

After determining users' presences, a ratio of returning users to one-time users (i.e., repeat presences to single presences) is determined to determine a scoring signal based on the users' presences (block 406). In some embodiments, a returning user may include a user having more than one presence at an entity within a time period, e.g., three presences at an entity within one week. Thus, in some embodiments, a one-time user may include a user having only a single presence at an entity within the same duration. A scoring is determined based on the ratio. For example, if the ratio is greater than a threshold (e.g., greater than one), a positive scoring signal may be determined. The value of the positive scoring signal may be proportional to the ratio of returning users to one-time users. Similarly, if the ratio is less than a threshold (e.g., less than one), then a negative scoring signal is determined. The value of the negative scoring signal may be proportional to the ratio of returning users to one-time users.

After determining a scoring signal based on the users' presences, an entity score associated with the entity is modified (block 408). For example, the entity score may be increased if a positive scoring signal is determined from the users' presences and may be decreased if a negative scoring signal is determined from the users' presences. As noted above, the increase or decrease of the entity score may be proportional to the value of the scoring signal that provided the basis for the modification of the entity score.

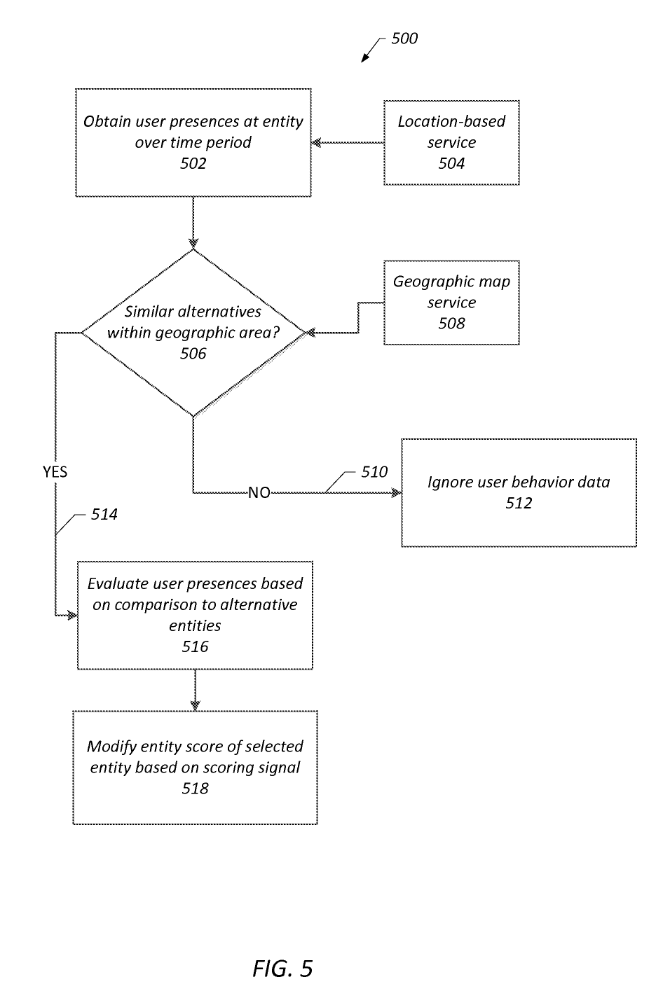

As also mentioned above, in some embodiments a scoring signal is determined from user choices, e.g., a user selecting an entity over other alternative entities within a geographic area. FIG. 5 depicts a process 500 for determining a scoring signal from choice user behaviors in accordance with an embodiment of the present invention. Initially, user presences at an entity are obtained (block 502), such as from a location-based service 504. The user presences may indicate one or more user presences at an entity over a time period. Next, alternative entities within a geographic area are obtained (block 506) such as from a geographic map service 508. The alternative entities may be determined based on parameters similar to the selected entity. For example, the alternative entities may be determined based on an entity category, price range, dress code, or other parameters. If alternative entities within a geographic area do not exist (line 510), then the user behavior data is ignored and no scoring signal is determined (block 512). In this example, the user's presence at the selected entity does not indicate a preference over other alternative entities in a geographic area, as alternative entities do not exist.

If the alternative entities to the selected entity exist within a geographic area (line 514), then the user presences at the selected entity based on a comparison to the alternative entities may be evaluated to determine a scoring signal (block 516). For example, if a user has multiple presences at the selected entity within a time period despite the existence of similar areas with the geographic area, a positive scoring signal is determined. The value of positive scoring signal may be proportional to the number of multiple presences at the selected entity, the number of alternative entities, the distance between the user's default location and the selected entity, the distance between the user's default location and the alternative entities, or any combination thereof.

After determining a scoring signal based on the aggregated payment transactions, an entity score associated with the entity is modified (block 518). For example, the entity score may be increased if a positive scoring signal is determined from the user presences and may be decreased if a negative scoring signal is determined from the user presences. The increase or decrease of the entity score may be proportional to the value of the scoring signal providing the basis for the modification of the entity score. Moreover, it should be appreciated that the scoring signal may include evaluation of user presences for multiple presences, such that multiple users choosing a selected entity over alternative entities within a geographic area may result in a higher value of a positive scoring signal.

In some embodiments, a negative scoring signal may be determined for alternative entities if the selected entity is less accessible to the user (less accessible to the user). For example, if a user has multiple presences at the selected entity and the selected entity is a threshold distance further away from the user's location than alternative entities in a geographic area, a negative scoring signal for the alternative entities may be determined.

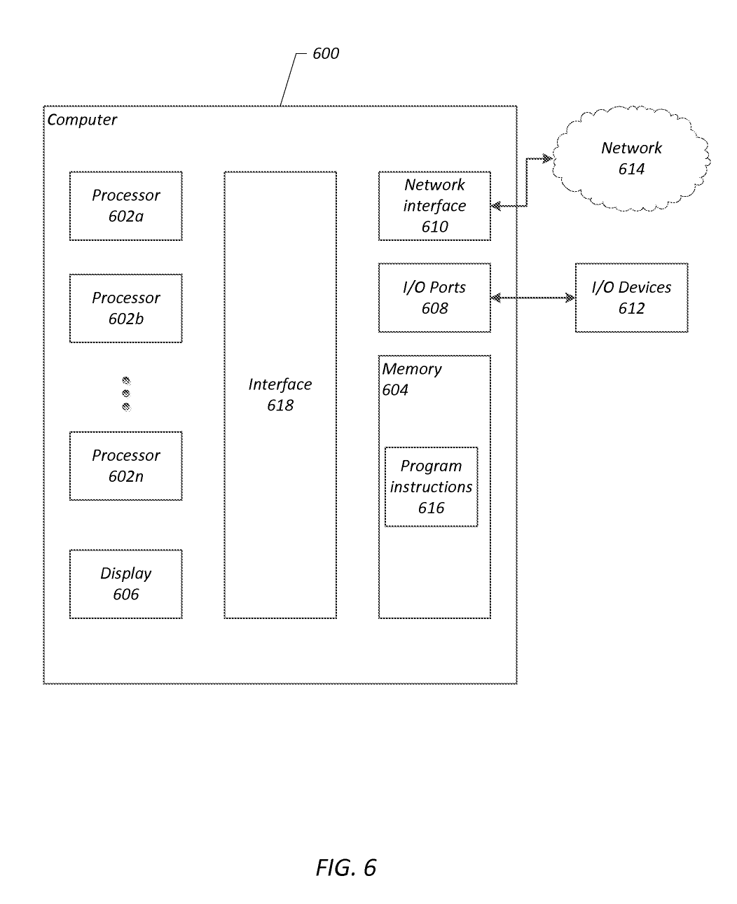

FIG. 6 depicts a computer 600 in accordance with an embodiment of the present invention. Various portions or sections of systems and methods described herein include or are executed on one or more computers similar to computer 600 and programmed as special-purpose machines executing some or all steps of methods described above as executable computer code. Further, processes and modules described herein may be executed by one or more processing systems similar to that of computer 600.

The computer 600 may include various internal and external components that contribute to the function of the device and which may allow the computer 600 to function in accordance with the techniques discussed herein. As will be appreciated, various components of computer 600 may be provided as internal or integral components of the computer 600 or may be provided as external or connectable components. It should further be noted that FIG. 6 depicts merely one example of a particular implementation and is intended to illustrate the types of components and functionalities that may be present in computer 600.

Computer 600 may include any combination of devices or software that may perform or otherwise provide for the performance of the techniques described herein. For example, computer 600 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 600 may be a unified device providing any one of or a combination of the functionality of a media player, a cellular phone, a personal data organizer, a game console, and so forth. Computer 600 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

In addition, the computer 600 may allow a user to connect to and communicate through a network 614 (e.g., the Internet, a local area network, a wide area network, etc.) and to acquire data from a satellite-based positioning system (e.g., GPS). For example, the computer 600 may allow a user to communicate using e-mail, text messaging, instant messaging, or using other forms of electronic communication, and may allow a user to obtain the location of the device from a satellite-based positioning system, such as the location on an interactive geographic map. As shown in FIG. 6, the computer 600 may include one or more processors (e.g., processors 602a-602n) coupled to a memory 604, a display 606, I/O ports 608 and a network interface 610, via an interface 618.

In one embodiment, the display 606 may include a liquid crystal display (LCD) or an organic light emitting diode (OLED) display, although other display technologies may be used in other embodiments. The display 606 may display a user interface (e.g., a graphical user interface). The display 606 may also display various function and system indicators to provide feedback to a user, such as power status, call status, memory status, etc. These indicators may be in incorporated into the user interface displayed on the display 606. In accordance with some embodiments, the display 606 may include or be provided in conjunction with touch sensitive elements through which a user may interact with the user interface. Such a touch-sensitive display may be referred to as a “touch screen” and may also be known as or called a touch-sensitive display system.

The processor 602 may provide the processing capability required to execute the operating system, programs, user interface, and any functions of the computer 600. The processor 602 may include one or more processors and include “general-purpose” microprocessors and special purpose microprocessors, such as ASICs. For example, the processor 602 may include one or more reduced instruction set (RISC) processors, such as those implementing the Advanced RISC Machine (ARM) instruction set. Additionally, the processor 602 may include single-core processors and multicore processors and may include graphics processors, video processors, and related chip sets. A processor may receive instructions and data from a memory (e.g., system memory 604). Accordingly, computer 600 may be a uni-processor system including one processor (e.g., processor 602a), or a multi-processor system including any number of suitable processors (e.g., 602a-602n). Multiple processors may be employed to provide for parallel or sequential execution of one or more sections of the techniques described herein. Processes, such as logic flows, described herein may be performed by one or more programmable processors executing one or more computer programs to perform functions by operating on input data and generating corresponding output.

The memory 604 (which may include one or more tangible non-transitory computer readable storage medium) may include volatile memory and non-volatile memory accessible by the processor 602 and other components of the computer 600. The memory 604 may store a variety of information and may be used for a variety of purposes. For example, the memory 604 may store executable computer code, such as the firmware for the computer 600, an operating system for the computer 600, and any other programs or other executable code necessary for the computer 600 to function. The executable computer code may include program instructions 616 executable by a processor (e.g., one or more of processors 602a-602n) to implement one or more embodiments of the present invention. Instructions 616 may include modules of computer program instructions for implementing one or more techniques described herein with regard to various processing modules. Program instructions 616 may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a section of a file that holds other programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more computer processors located locally at one site or distributed across multiple remote sites and interconnected by a communication network. In addition, the memory 604 may be used for buffering or caching during operation of the computer 600.

As mentioned above, the memory 604 may include volatile memory, such as random access memory (RAM). The memory 604 may also include non-volatile memory, such as ROM, flash memory, a hard drive, any other suitable optical, magnetic, or solid-state storage medium, or a combination thereof. The memory 604 may store data files such as media (e.g., music and video files), software (e.g., for implementing functions on computer 600), preference information (e.g., media playback preferences), transaction information (e.g., information such as credit card information), wireless connection information (e.g., information that may enable media device to establish a wireless connection such as a telephone connection), telephone information (e.g., telephone numbers), and any other suitable data.

The interface 618 may include multiple interfaces and may couple various components of the computer 600 to the processor 602 and memory 604. In some embodiments, the interface 618, the processor 602, memory 604, and one or more other components of the computer 600 may be implemented on a single chip, such as a system-on-a-chip (SOC). In other embodiments, these components, their functionalities, or both may be implemented on separate chips. The interface 618 may be configured to coordinate I/O traffic between processors 602a-602n, system memory 604, network interface 610, I/O devices 612, other peripheral devices, or a combination thereof. The interface 618 may perform protocol, timing or other data transformations to convert data signals from one component (e.g., system memory 604) into a format suitable for use by another component (e.g., processors 602a-602n). The interface 618 may include support for devices attached through various types of peripheral buses, such as a variant of the Peripheral Component Interconnect (PCI) bus standard or the Universal Serial Bus (USB) standard.

The computer 600 may also include an input and output port 608 to allow connection of additional devices, such as I/O devices 612. Embodiments of the present invention may include any number of input and output ports 608, including headphone and headset jacks, universal serial bus (USB) ports, Firewire or IEEE-1394 ports, and AC and DC power connectors. Further, the computer 600 may use the input and output ports to connect to and send or receive data with any other device, such as other portable computers, personal computers, printers, etc.

The computer 600 depicted in FIG. 6 also includes a network interface 610, such as a wired network interface card (NIC), wireless (e.g., radio frequency) interface cards, etc. For example, the network interface 610 may receive and send electromagnetic signals and communicate with communications networks and other communications devices via the electromagnetic signals. The network interface 610 may include known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The network interface 610 may communicate with networks (e.g., network 614), such as the Internet, an intranet, a cellular telephone network, a wireless local area network (LAN), a metropolitan area network (MAN), or other devices by wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11a, IEEE 802.11b, IEEE 802.11g or IEEE 802.11n), voice over Internet Protocol (VoIP), Wi-MAX, a protocol for email (e.g., Internet message access protocol (IMAP) or post office protocol (POP)), messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), Short Message Service (SMS), or any other suitable communication protocol.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for determining an entity score based on user behaviors associated with an entity, the method comprising:
identifying, one or more processors, a plurality of user payment transactions with the entity;
comparing an average tip amount determined from the plurality of user payment transactions with a baseline tip amount determined from historical user payment transactions to determine a scoring signal;
modifying, by one or more processors, a score associated with the entity based on the scoring signal; and
storing, by one or more processors, the score and an entity identifier associated with the entity.

2. The method of claim 1, comprising comparing a tip frequency from the plurality of user payment transactions with a baseline tip frequency determined from the historical user payment transactions to further determine the scoring signal.

3. The method of claim 1, comprising:
determining, by one or more processors, a number of tips of the plurality of user payment transactions; and
determining, by one or more processors, an amount of each tip of each of the plurality of user payment transactions.

4. The method of claim 1, comprising identifying a plurality of users presences at the entity.

5. The method of claim 4, comprising determining, based on the plurality of users presences a ratio of a number of repeat presences at the entity to a number of single presences.

6. The method of claim 5, comprising comparing the ratio to a baseline ratio to further determine the scoring signal.

7. The method of clam 1, wherein modifying, by one or more processors, a score associated with the entity based on the scoring signal comprises increasing the score associated with the entity if the average tip amount is above the baseline tip amount and decreasing the score associated with the entity if the average tip amount is below the baseline tip amount.

8. The method of clam 3, wherein modifying, by one or more processors, a score associated with the entity based on the scoring signal comprises increasing the score associated with the entity if the tip frequency is above the baseline tip frequency and decreasing the score associated with the entity if the tip frequency is below the baseline tip frequency.

9. The computer-implemented method of claim 1, comprising ranking, by one or more processors, the entity among a plurality of second entities based on the score and transmitting the ranked entity and plurality of second entities to a client computer in response to a search query.

10. A non-transitory tangible computer-readable storage medium having executable computer code stored thereon for determining a score associated with an entity based on user behaviors, the code comprising a set of instructions that causes one or more processors to perform the following:
identifying, one or more processors, a plurality of user payment transactions with the entity;
comparing an average tip amount determined from the plurality of user payment transactions with a baseline tip amount determined from historical user payment transactions to determine a scoring signal;
modifying, by one or more processors, a score associated with the entity based on the scoring signal; and
storing, by one or more processors, the score and an entity identifier associated with the entity.

11. The non-transitory tangible computer-readable storage medium of claim 10, the code further comprising a set of instructions that causes one or more processors to perform the following: comparing a tip frequency from the plurality of user payment transactions with a baseline tip frequency determined from the historical user payment transactions to further determine the scoring signal.

12. The non-transitory tangible computer-readable storage medium of claim 10, the code further comprising a set of instructions that causes one or more processors to perform the following:
determining, by one or more processors, a number of tips of the plurality of user payment transactions; and
determining, by one or more processors, an amount of each tip of each of the plurality of user payment transactions.

13. The non-transitory tangible computer-readable storage medium of claim 10, the code further comprising a set of instructions that causes one or more processors to perform the following: identifying a plurality of users presences at the entity.

14. The non-transitory tangible computer-readable storage medium of claim 13, the code further comprising a set of instructions that causes one or more processors to perform the following: determining, based on the plurality of users presences a ratio of a number of repeat presences at the entity to a number of single presences.

15. The non-transitory tangible computer-readable storage medium of claim 14, the code further comprising a set of instructions that causes one or more processors to perform the following: comparing the ratio to a baseline ratio to further determine the scoring signal.

16. The non-transitory tangible computer-readable storage medium of claim 10, the code further comprising a set of instructions that causes one or more processors to perform the following: ranking, by one or more processors, the entity among a plurality of second entities based on the score and transmitting the ranked entity and plurality of second entities to a client computer in response to a search query.

17. A system for determining a score associated with an entity based on user behaviors, the system comprising
one or more processors; and
non-transitory memory accessible by the one or more processors, the memory having computer code stored thereon, the code comprising a set of instructions that causes one or more processors to perform the following:
identifying, one or more processors, a plurality of user payment transactions with the entity;
comparing an average tip amount determined from the plurality of user payment transactions with a baseline tip amount determined from historical user payment transactions to determine a scoring signal;
modifying, by one or more processors, a score associated with the entity based on the scoring signal; and
storing, by one or more processors, the score and an entity identifier associated with the entity.

18. The system of claim 17, the code further comprising a set of instructions that causes one or more processors to perform the following: comparing a tip frequency from the plurality of user payment transactions with a baseline tip frequency determined from the historical user payment transactions to further determine the scoring signal.

19. The system of claim 17, the code further comprising a set of instructions that causes one or more processors to perform the following:
determining, by one or more processors, a number of tips of the plurality of user payment transactions; and
determining, by one or more processors, an amount of each tip of each of the plurality of user payment transactions.

20. The system of claim 17, the code further comprising a set of instructions that causes one or more processors to perform the following: identifying a plurality of users presences at the entity.

21. The system of claim 20, the code further comprising a set of instructions that causes one or more processors to perform the following: determining, based on the plurality of users presences, a ratio of a number of repeat presences at the entity to a number of single presences.

22. The system of claim 21, the code further comprising a set of instructions that causes one or more processors to perform the following: comparing the ratio to a baseline ratio to further determine the scoring signal.

23. The system of claim 17, the code further comprising a set of instructions that causes one or more processors to perform the following: ranking, by one or more processors, the entity among a plurality of second entities based on the score and transmitting the ranked entity and plurality of second entities to a client computer in response to a search query.
